(19) United States
(12) Patent Application Publication
(10) Pub. No.: US 2022/0057829 A1
(43) Pub. Date: Feb. 24, 2022

(54) Wearable technology including ultra-thin led panels/screen

(71) Applicant: Scott Mitchell Schreiner, Loveland, CO (US)

(72) Inventor: Scott Mitchell Schreiner, Loveland, CO (US)

(21) Appl. No.: 17/405,122

(22) Filed: Aug. 18, 2021

Related U.S. Application Data
(60) Provisional application No. 63/067,478, filed on Aug. 19, 2020.

(51) Int. Cl. G06F 1/16; G10L 15/26; G06F 3/16

(52) U.S. Cl. CPC G06F 1/163; G06F 3/16; G10L 15/26

(57) ABSTRACT

A wearable breathing mask configured to display wearer's spoken words on LED display panel. The face mask comprises a face mask body to keep the filter, a filter to remove the pollution particles, an adjustable elastic to fit the user face, wherein the LED panel displays the words that are spoken into a small microphone, attached to the interior of the mask. These LED display panel allows the ability to attach to hats, helmets, shirts, coats, and other clothing or safety gear and can be powered by rechargeable battery. The assembly is lightweight, adjustable and comfortable.

### CROSS-REFERENCE TO RELATED APPLICATIONS

This application claims priority to the following U.S. Provisional Patent Application, of which is hereby incorporated by reference in its entirety: U.S. Ser. No. 63067478 filed 19 Aug. 2020.

### FIELD OF THE INVENTION

The present invention relates to wearable breathing masks and, more particularly, to wearable LED panel display mask, where the words that are spoken into a small microphone are displayed.

### DESCRIPTION OF THE RELATED ART

Face masks are a symbol of the pandemic era—a visual metaphor for the tiny, unseen viral foe that could be lurking around any corner. Furthermore, air pollution has become an increasing threat to humans due to industrialization and de-forestation, resulting in increasing cases of human respiratory illnesses, pollution related complications of cardiovascular conditions and conditions related to the organs, resulting in an increase in health care costs. Wearing a mask in daily life is becoming a norm in many places around the world.

Some opt for a scarf wrapped around their face, others make do with a t-shirt yanked up over their mouth. The more creative hook colorful homemade varieties around their ears, while a lucky few wear distinctive surgical masks or, rarer still, N95 respirators.

While a few months ago anyone wearing a mask in public would have drawn stares in many countries unused to this behavior, they are now a reminder of the strange times we live in. And as governments around the world start to ease their lockdowns to allow their citizens out to mingle in the wider world again, growing numbers of people are opting to wear face masks in public.

There are multiple types of enhancements that can be seen in prior art regarding face masks. For instance a multipurpose therapeutic face mask bearing US patent 2,013,0276784A1 is issued to Stephen Donald Flynn, SR. The patent is on a therapeutic face mask comprises a face-engaging portion and a single connector having a mask-engaging end and a single treatment receiving end which has a single attachment mounting for detachably sealingly receiving a treatment attachment, such as an oxygen reservoir bag or a nebulizer. A one-way inhalation valve in the connector permits fluid flow from the treatment-receiving end to the mask-engaging end during inhalation and inhibits fluid flow in the other direction. The mask also includes a valve governed exhalation port and an anti-asphyxia valve assembly configured to permit fluid flow from ambient to the face-engaging portion during inhalation only when inspiratory effort during inhalation exceeds fluid flow to the treatment-receiving end of the connector. Also provided is an oxygen reservoir bag having a neck shaped for removable coupling to a mating connector of a therapeutic face mask. An oxygen reservoir bag may have a metered-dose inhaler port defined in its neck.

Another patent on Adjustable facial conforming face mask bearing US patent 2,017,0095681A1 is issued to BALBOA MANUFACTURING COMPANY LLC. The patent is on an adjustable face mask having a body conforming substantially to the facial structure of a wearer. The face mask is provided with a neck protector and removable filter and with a strip of fabric designed to push air down to the sides of the wearer's face in order to eliminate fogging of the wearer's goggles. The face mask can optionally provide neck protection with a descending neck member.

Another patent on Full-face mask and mask cushion therefor bearing US patent 2,014,0360506A1 is issued to Resmed Pty Ltd. The patent is on a full-face cushion comprises a substantially triangularly shaped frame from which extends a membrane. The frame has a scalloped edge by which the cushion is affixed to a mask body to form a full-face mask. The membrane has an aperture into which the wearer's nose is received. The member is spaced away from the rim of the frame, and its outer surface is of substantially the same shape as the rim. Respective notches receive the bridge of the wearer's nose. The wearer's nose and lips are received through the aperture into the chamber within the mask body. The seal forming portion thus contacts both the surface of the wearer's nose and a portion of the wearer's face in the region between the bottom lip and the chin, and around the sides and over the bridge of the nose. The shape of the seal forming portion is particularly suited to effectively seal the difficult region of the facial contour that is the crease between the sides of the nose and the face.

Another Face mask bearing US patent 2,016,0113336A1 is issued to Uni Charm Corp. The patent is on a mask has a mask body and a pair of ear straps. The mask body includes an outer layer sheet and an intermediate layer sheet. The outer layer sheet is formed of hydrophobic fibers. The intermediate layer sheet is laid on the outer layer sheet so as to be located on a wearer's side of the outer layer sheet when the mask is worn. The intermediate layer sheet includes a first fiber layer which is formed of polyolefin fibers containing an inorganic antimicrobial agent and a second fiber layer which is formed of polyolefin fibers and has a larger fiber diameter than the first fiber layer. The fiber diameter of the first fiber layer is within a range of 0.5 to 2.8 μm and the ratio of a particle diameter of the inorganic antimicrobial agent with respect to the fiber diameter is within the range of 0.1 to 6.0.

A Cold Weather Exposure Mask bearing US patent 2,014,0283280A1 is issued to TALUS OUTDOOR TECHNOLOGIES LLC. The patent is on a Cold or Inclement Weather Exposure Mask is designed to fit snugly around the wearer's face, head, and neck. The mask serves vital needs of warmth, humidity, moisture management and air flow. A raised, pliable chamber covering the mouth and nose of the wearer provides a breathing space to allow normal breathing while keeping the face warm and dry. The chamber is affixed to a fabric panel made of a water and wind resistant, non-irritating, comfortable, and stretchable material. A fastening means on the panel holds the mask in place around the wearer. The chamber includes multiple apertures which allow fresh, ambient air to pass to the wearer after it is mixed with warm, humid, exhaled air. The apertures also exhaust breath, air and condensation. Colors and pattern selections allow adaptation to all labor and recreation uses.

Another patent on Respiratory mask assembly bearing U.S. Pat. No. 8,479,736B2 is issued to Resmed Pty Ltd. The patent is on a respiratory mask assembly for delivering breathable gas to a patient includes a frame having a main body and a side frame member provided on each lateral side of the main body. Each side frame member includes an integrally formed first connector portion. A headgear assembly is removably attachable to the frame. The headgear assembly has a second connector portion adapted to be removably coupled with the first connector portion provided on the frame. The second connector portion is manually movable to a releasing position to detach the headgear assembly from the frame. The headgear assembly is rotationally adjustable with respect to the frame.

A Mask system bearing U.S. Pat. No. 8,528,561B2 is issued to Resmed Pty Ltd. The patent is on a mask includes a shroud; a cushion module that engages the shroud, the cushion module including a frame and a full-face cushion adapted to engage the patient's face generally along nasal bridge, cheek, and chin regions of the patient's face, the frame at least partly defining a breathing chamber; an elbow connected to the frame in a releasable and rotatable manner, the elbow being adapted to be connected to an air delivery tube to deliver breathable gas to the patient; and headgear removably attachable to the shroud, wherein: the frame includes an opening, the elbow including a distal end releasably inserted into the opening of the frame with a snap-fit, thereby connecting the elbow to the frame, whereby the connection between the elbow and the frame also maintains the shroud in engagement with the frame.

There are multiple solutions that have been presented in prior art. However, these solutions are limited and restricted to their conventional architecture, installation system and have considerable shortcomings which adversely affect the convenience with which they can be used. The prior systems have certain limitations including the design of assemblies which make them not suitable for every type of user. Moreover, the ease of use ability of these assemblies is also questionable.

It has to be noted that the current invention proposes an assembly with an advancement of a face mask with a wearable tech that includes ultra-thin led panels/screen that cover a breathable fabric or mask made of other materials. The LED panel displays the words that are spoken into a small microphone, attached to the interior of the mask. These LED display panel would have the ability to attach to hats, helmets, shirts, coats, and other clothing or safety gear.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a face mask assembly with wearable technology that includes ultra-thin led panels/screen that cover a breathable fabric or mask made of other materials.

Another object of the present invention is to provide a message display mask, comprising a face mask having an exterior surface, an interior surface, and a perimeter extending seal, wherein the face mask is adapted to overlay a user's mouth and nose; an outer layer overlaying the face mask and having a pair of straps with inter-engaging ends for affixing the face mask about the user's face; at least one air inlet valve assembly incorporated within the face mask; and at least one air outlet valve assembly incorporated within the face mask and including at least one display screen to display wearer's messages.

Another object of this invention is to provide a new and improved mask according to this invention which is designed to be worn on a wearer's face and includes at least a mask body and a pair of ear straps. The mask may be of disposable type designed for a single or multiple use which can be used once or several times, or reusable type which can be reused by washing.

It is an object of the invention in one of its aspects to provide at least one LED display panel which has the ability to attach to hats, helmets, shirts, coats, and other clothing or safety gear. The unit would be powered by rechargeable battery. The battery can be charged via USB connection.

It is another objective of the invention to provide a main assembly with variety of options where the device converts spoken word into readable display on the panel of the mask. The intent is to have the ability to communicate clearly from a distance

It is another object to provide a reliable construction which includes the mask proposed to be made out of ultra-micro filter disc which is PM2.5 ultra-micro filter disc. This anti-dust mask is ideal for both women and men, suitable for cycling, camping, running, travel, climbing and daily use.

Yet another object of the present invention is to provide a mask structure that is relatively inexpensive to produce so that ownership is available to a substantial majority of families.

It is also the objective of the invention to provide a smart assembly which provide ease of use and convenience to everyone. The mask can be attached itself to any pair of eye wear namely; Prescription glasses, safety glasses, sunglasses, etc.

It is a further aspect of the present invention to provide a new and improved assembly which is of a durable and reliable construction and can sustain its effectiveness after multiple and consistent use.

Thus, it is the objective to provide a new and improved mask assembly with message display mask. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide an improved face mask with display panel to communicate wearer's speech, comprising a face mask having an exterior surface, an interior surface, and a perimeter extending seal, wherein the face mask is adapted to overlay a user's mouth and nose; an outer layer overlaying the face mask and having a pair of straps with inter-engaging ends for affixing the face mask about the user's face; at least one air inlet valve assembly incorporated within the face mask; and at least one air outlet valve assembly incorporated within the face mask and including at least display panel to display user's speech on thin LED screen.

In an embodiment, as proven the wearable mask includes ultra-thin LED panels/screen that cover a breathable fabric or mask made of other materials. The LED panel displays the words that are spoken into a small microphone, attached to the interior of the mask. These LED display panel would have the ability to attach to hats, helmets, shirts, coats, and other clothing or safety gear.

The mask assembly as per its further embodiments can be powered by rechargeable battery. The battery would recharge via USB connection. The unit has a device that converts spoken word into readable display on the panel of the mask. This provides the ability to communicate speech clearly from a distance. Furthermore, this also promotes social distancing.

The device as per its additional embodiment also provides ease of communication between two or more people in an emergency setting or industrial area in which vital communication needs to occur. The ‘host’ device can be paired with other ‘client’ units and each different unit will have its own LED color, accordingly. You can connect with your mobile device to display a text message or image stored on the mobile device. An option would be to have a small amount of storage, in that you could display images, stored on the device.

Two or more of the ‘client’ units can also be linked to display the content of the ‘host’ device. Commands or instructions could be displayed on multiple, connected units simultaneously.

The technical problem to be solved in the utility model is for abovementioned the deficiencies in the prior art, and a kind of face mask with compounds that provides text translation. This face mask has been introduced some components, greatly improved the message communication in any environment where user is present.

The filter used for filtration of fine dust and harmful substances contained in the outside air when the user inhales the outside air by wearing a mask and breathing in. Protect the bronchus of the user by performing sterilization, disinfection and fragrance by including an aromatic substance in the part.

In an embodiment of the present invention, above-mentioned a kind of face mask with fragrance components, described ultra-micro filter disc is PM2.5 ultra-micro filter disc. This anti-dust mask is ideal for both women and men, suitable for cycling, camping, running, travel, climbing and daily use.

In an embodiment, of the present invention the advantages including but not limited to allowing the protection from pollution by filtering out majority of the particles through its multiple layers, very soft fabric at the back to provide skin safety, removable carbon activated filters to provide further safety from dust particles, with LED display to promote user's messages as the user requirement. It is a lightweight, adjustable and comfortable assembly.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a perspective view;

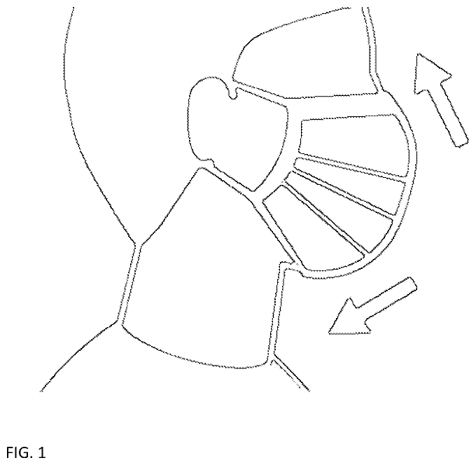

FIG. 2 is a side plan view thereof;

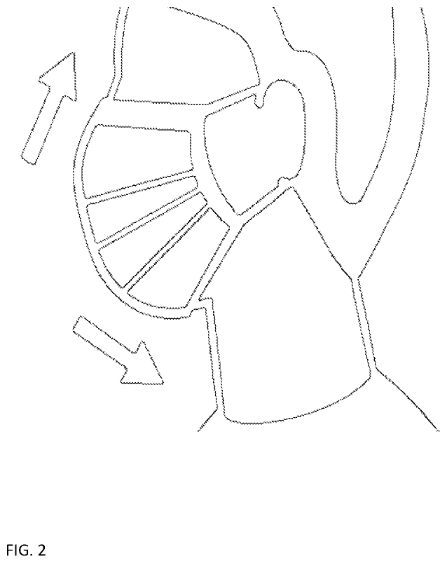

FIG. 3 shows our unique Invention.

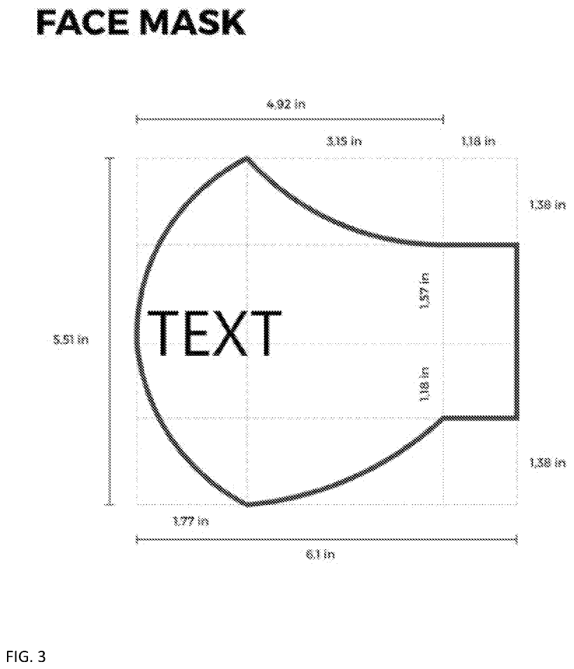

1. A face mask with LED panel comprising:
a face mask having an exterior surface, an interior surface, and a perimeter extending seal, wherein said face mask is adapted to overlay a user's mouth and nose;
an outer layer overlaying said face mask and having a pair of straps with inter-engaging ends for affixing the face mask about the user's face;
at least one air inlet valve assembly incorporated within said face mask; and
at least one air outlet valve assembly incorporated within said face mask and including at least one LED display panel.
wherein said at least one LED display panel is supported on said front area of the mask. wherein said assembly of LED display panel would have the ability to attach to hats, helmets, shirts, coats, and other clothing or safety gear.

2. The mask of claim 2, wherein said assembly would be powered by rechargeable battery. The battery would recharge via USB connection. The unit has a device that converts spoken word into readable display on the panel of the mask.
